(19) United States
(12) Patent Application Publication
(10) Pub. No.: US 2025/0252393 A1
(43) Pub. Date: Aug. 7, 2025

(54) DIGITAL TRANSPORT SYSTEM AND METHOD THEREOF

(71) Applicant: ALLY LOGISTIC PROPERTY CO., LTD., Taipei City (TW)

(72) Inventor: CHIEN-TAI CHANG, Taipei City (TW)

(21) Appl. No.: 18/771,460

(22) Filed: Jul. 12, 2024

(30) Foreign Application Priority Data
Feb. 7, 2024 (TW) 113104869

(51) Int. Cl. G06Q 10/087

(52) U.S. Cl. CPC G06Q 10/087

(57) ABSTRACT

The present invention provides a digital transport system and method applied to warehouse environment providing goods storage for senders and recipients. The system includes connection, setting, receiving, determining, and reporting modules. The connection module connects a warehouse management system of the senders and recipients through an application interface. The setting module is used to set the transport request as direct transport. The receiving module receives a request task from sender's warehouse management system through the application interface. The determining module determines if the request task is direct transport; if it is, a simplified signal is generated. The reporting module, according to the simplified signal, sends the request task and an integrated report command to recipient's warehouse management system through the application interface. The recipient's warehouse management system automatically completes a goods transport report of the request task in the warehouse management system accordingly.

### BACKGROUND OF THE INVENTION

### 1. Field of the Invention

The present invention relates to goods transport fields, and more particularly, to a digital transport system with simplified goods transport and reporting procedure and method thereof.

### 2. Description of the Related Art

Conventional goods distribution systems suffer from complex challenges in system reporting processes during stages such as vehicle scheduling, goods picking, packaging, loading, dispatching, checking on delivery, and shelving, which cause direct impacts on overall efficiency. Each of said stages requires a real-time progress reporting, and the accuracy and timeliness of reporting directly determine the smoothness of the goods distribution process.

Also, manual steps involved in conventional transport methods, such as manual picking, packaging, and distribution, shall not be ignored, and those steps consume a significant amount of manpower and time. For example, during the vehicle scheduling stage, the system has to efficiently report the route plans to cope with real-time traffic changes, and the reporting process requires manpower participation. The reporting process at the stages of goods picking, packaging, loading, dispatching, checking on delivery, and shelving is equally crucial. Delay or error in any of these stages might lead to disruptions in the overall process.

In short, the cost of manpower and time during manual picking, packaging, and distribution in conventional transport methods are closely related to the system reporting processes required at various stages of conventional goods distribution systems. Those factors affect the efficiency and smoothness of overall goods distribution.

### SUMMARY OF THE INVENTION

To improve the issues above, the present invention discloses a digital transport system and method thereof. By utilizing integrated report commands, the goods transport process automatically generates reports, so as to enhance efficiency, reduce risk of error, provide real-time feedback on changes, ensure smoothness of process, and improve customer satisfaction.

For achieving the objectives above, an embodiment in accordance with the present invention provides a digital transport system, which is disposed on a server and applied to a warehouse environment having a plurality of storage areas, each storage area providing goods storage for a plurality of goods senders and recipients, the digital transport system comprising:
a connection module connecting a warehouse management system of each of the senders and each of the recipients through an application interface;
a setting module coupled with the connection module, the setting module allowing each sender and recipient to set up a direct transport according to a transport request of goods on the setting module;
a receiving module coupled with the connection module, the receiving module receiving a request task from the warehouse management system of the sender through the application interface, wherein the request task comprises a task information and one corresponding recipient;
a determining module coupled with the setting module and the receiving module, the determining module determining if the transport request corresponding to the request task is direct transport; when the determining module determines that the transport request corresponding to the request task is a direct transport, the determining module generates a simplified signal; and
a reporting module coupled with the determining module, the reporting module receiving the simplified signal from the determining module, and sending the task information of the request task and an integrated report command to the warehouse management system of the recipient through the application interface, the warehouse management system of the recipient automatically completing a goods transport report of the request task in the warehouse management system according to the integrated report command.

Another embodiment of the present invention provides a digital transport method using digital transport system, the digital transport method applied to a warehouse environment having a plurality of storage areas, each storage area providing goods storage for a plurality of goods senders and recipients; the digital transport method comprising:
a connection step: connecting a warehouse management system of each of the senders and each of the recipients through an application interface:
a transport setting step: each sender and recipient setting a transport request of goods as direct transport on the warehouse management system;
a task determining step: the application interface receiving a request task from the warehouse management system of the sender, the application interface determining if the transport request corresponding to the request task is direct transport;
when the application interface determines that the transport request corresponding to the request task is a direct transport, the application interface generates a simplified signal, wherein the request task comprises a task information and one corresponding recipient;
a simplified reporting step: the application interface sending the task information of the request task and an integrated report command to the warehouse management system of the recipient, the warehouse management system of the recipient automatically completing the goods transport report of the request task in the warehouse management system according to the integrated report command.

With such configuration, the present invention utilizes the integrated report command to automatically complete the report operation of the goods transport process, so as to improve the system intelligence for achieving a smoother and more efficient goods distribution, thereby improving overall transport efficiency and providing customers with a superior service experience.

Also, the present invention utilizes the integrated report command to automatically complete the report operation of the goods transport process, reducing the reporting steps and simplifying the overall procedure, thereby lowering the possibility of errors and enhancing the accuracy of goods information.

Furthermore, the present invention significantly saves or reduces the costs of manpower and transport.

### BRIEF DESCRIPTION OF THE DRAWINGS

FIG. 1 is a block view of the system in accordance with an embodiment of the present invention.

FIG. 2 is a flow chart of the method in accordance with an embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

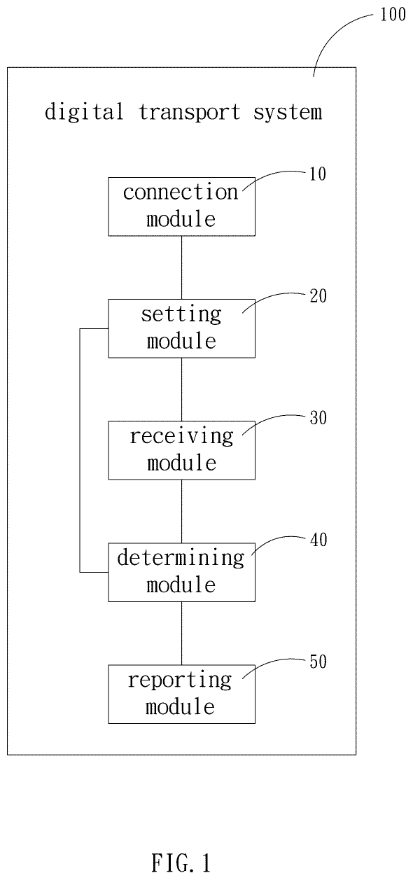

Referring to FIG. 1, the present invention provides a digital transport system 100 disposed on a server. The digital transport system 100 is applied to a warehouse environment having a plurality of storage areas. Each storage area provides goods storage for a plurality of goods senders and recipients. In other words, the goods of the sender and the recipient are placed in the same warehouse environment. If the sender and the recipient have upstream or downstream relationship therebetween, the demand for goods distribution can be fulfilled by simply moving the to-be-transported goods between the corresponding storage areas in the warehouse environment.

The digital transport system 100 of the present invention comprises a connection module 10, a setting module 20, a receiving module 30, a determining module 40, and a reporting module 50.

The connection module 10 connects a warehouse management system (WMS) of senders and recipients through an application interface. The present invention does not specifically limit the warehouse management system to existing systems or self-developed systems.

The setting module 20 is coupled with the connection module 10. The setting module 20 allows each sender and recipient to set up a direct transport according to a transport request of goods on the setting module 20. Direct transport indicates that the sender or recipient is able to directly receive the goods (whether for goods shipping or returning) without the need to inspect the goods before receiving or returning them.

In other possible embodiments of the present invention, the direct transport is allowed to be set up by either the sender or the recipient based on their respective requests, or the direct transport is allowed to be set up by both the sender and recipient. The invention does not specifically limit that both parties have to set up the direct transport, so it is adjustable according to actual needs

The receiving module 30 is coupled with the connection module 10. The receiving module 30 receives a request task from the warehouse management system of the sender or the recipient through the application interface. The request task comprises a task information and one corresponding sender or recipient. In other words, the receiving module 30 is able to receive the request task from the sender or the recipient in response to the goods shipping or returning request.

Also, when the request task is a purchase request, the recipient is allowed to establish a purchase order from the enterprise resource planning (ERP) system. The ERP system then sends the purchase order to the ERP system of the sender. The sender establishes an outbound order based on the purchase order, and the sender then transmits the outbound order to the sender's warehouse management system.

The determining module 40 is coupled with the setting module 20 and the receiving module 30. When the determining module 40 determines that the transport request refers to a direct transport, the determining module 40 generates a simplified signal.

The reporting module 50 is coupled with the determining module 40. The reporting module 50 receives the simplified signal from the determining module 40. According to the simplified signal, the reporting module 50 sends the task information of the request task and an integrated report command to the warehouse management system of the sender or the recipient through the application interface, and the warehouse management system of the sender or the recipient, according to the integrated report command, automatically completes the goods transport report of the request task in the warehouse management system. Therein, the integrated report command is used to report goods transport process of two and/or a combination of operations selected from, for example, vehicle scheduling, goods picking, packaging, loading, dispatching, checking on delivery, and shelving. The integrated report command varies in content depending on the shipping needs, such as goods sending, returning, or the target party being the sender or the recipient.

Notably, if the receiving module 30 receives the request task from the sender, the determining module 40 not only determines if the warehouse management system of the sender has set it as a direct transport, but also if the recipient has set it as a direct transport. On the other hand, if the receiving module 30 receives the request task from the recipient, the determining module 40 not only determines if the warehouse management system of the recipient has set it as a direct transport, but also if the sender has set it as a direct transport.

Therefore, when the determining module 40, after receiving the request task, determines that the warehouse management system of the recipient or the sender has set it as a direct transport, the reporting module 50 sends the task information of the request task and the integrated report command to the warehouse management system of the other party through the application interface, so as to ensure that both parties have set the direct transport.

However, in other embodiments, it may still be possible that as long as either the sender or the recipient has set the direct transport, the task information of the request task and the integrated report command are sent to warehouse management system of the corresponding party through application interface, so as to complete the simplified goods transport reporting operation.

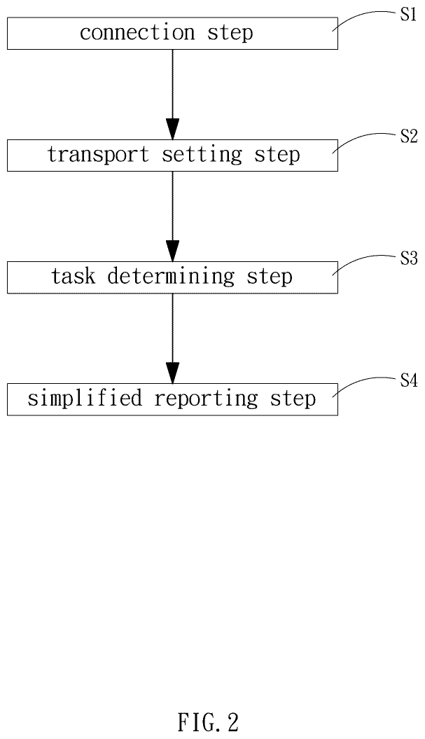

Referring to FIG. 1 and FIG. 2, another embodiment of the present invention provides a digital transport method using the digital transport system 100, comprising a connection step S1, a transport setting step S2, a task determining step S3, and a simplified reporting step S4.

In the connection step S1, the application interface is used to connect the warehouse management system of each sender and recipient. In the embodiment, the connection module 10 connects the warehouse management system of each sender and recipient through the application interface.

In the transport setting step S2, the after the connection step S1 connecting the warehouse management systems of the sender and the recipient, each sender and recipient is allowed to set a direct transport in the warehouse management system according to the transport request of goods. In the embodiment, the setting module 20 allows the recipient and sender to set the transport request of goods as direct transport.

In the task determining step S3, after the direct transport is set in the transport setting step S2, the application interface receives the request task from the warehouse management system of the recipient or sender, and the application interface determines if the transport request corresponding to the request task is a direct transport. When the application interface determines the transport request corresponding to the request task is a direct transport, the application interface generates the simplified signal. In the embodiment, the receiving module 30 receives the request task through the application interface, and the determining module 40 determines if the transport request of the corresponding request task is a direct transport. When the determination is positive, the determining module 40 generates the simplified signal.

In the simplified reporting step S4, after the simplified signal being generated in the task determining step S3, the application interface sends the task information of the request task and the integrated report command to the warehouse management system of the sender or the recipient according to the simplified signal, and the warehouse management system of the sender or the recipient automatically completes the goods transport report of the request task in the warehouse management system. In the embodiment, the reporting module 50 receives the simplified signal, and sends the task information of the request task and the integrated report command to the warehouse management system of the sender or the recipient through the application interface.

In the simplified reporting step S4 in the embodiment, according to the simplified signal, the reporting module 50 simultaneously determines if the warehouse management system of the sender and the recipient have both set the direct transport through the application interface. When the application interface determines that the warehouse management system of the sender and the recipient have both set the direct transport, the reporting module 50 sends the task information of the request task and the integrated report command to the warehouse system of the corresponding party through the application interface.

In other possible embodiments, during the simplified reporting step S4, with only one of the two parties has set up the direct transport, the simplified goods transport report is still able to be completed.

Therefore, the digital transport system 100 and the digital transport method of the present invention automatically complete the report of the goods transport process by use of the integrated report command, so as to improve the system intelligence for achieving a smoother and more efficient goods distribution, thereby improving overall transport efficiency and providing customers with a superior service experience.

Also, the digital transport system 100 and the digital transport method of the present invention utilize the integrated report command to automatically complete the report of the goods transport process, reducing the reporting steps and simplifying the overall procedure, thereby lowering the possibility of errors and enhancing the accuracy of goods information.

Furthermore, the digital transport system 100 and the digital transport method of the present invention significantly save or reduce the costs of manpower and transport.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A digital transport system disposed on a server and applied to a warehouse environment having a plurality of storage areas, each storage area providing goods storage for a plurality of goods senders and recipients; the digital transport system comprising:
a connection module connecting a warehouse management system of each of the senders and each of the recipients through an application interface;
a setting module coupled with the connection module, the setting module allowing each sender and recipient to set up a direct transport according to a transport request of goods on the setting module;
a receiving module coupled with the connection module, the receiving module receiving a request task from the warehouse management system of the sender through the application interface, wherein the request task comprises a task information and one corresponding recipient;
a determining module coupled with the setting module and the receiving module, the determining module determining if the transport request corresponding to the request task is set as the direct transport; when the determining module determines that the transport request corresponding to the request task is set as the direct transport, the determining module generates a simplified signal; and
a reporting module coupled with the determining module, the reporting module receiving the simplified signal from the determining module, and sending the task information of the request task and an integrated report command to the warehouse management system of the recipient through the application interface, the warehouse management system of the recipient automatically completing a goods transport report of the request task in the warehouse management system according to the integrated report command.

2. The digital transport system of claim 1, wherein when the request task is a purchase request, the recipient is allowed to establish a purchase order from an enterprise resource planning system; the enterprise resource planning system sends the purchase order to an enterprise resource planning system of the sender; the enterprise resource planning system of the sender establishes an outbound order based on the purchase order, and the sender transmits the outbound order to the warehouse management system of the sender.

3. The digital transport system of claim 2, wherein the determining module determines if the warehouse management system of the recipient has set the transport request as the direct transport; when the determining module determines that the warehouse management system of the recipient has set the transport request as the direct transport, the reporting module sends the task information of the request task and the integrated report command to the warehouse management system of the recipient through the application interface.

4. The digital transport system of claim 3, wherein the integrated report command is used to conduct the goods transport report which includes two and/or a combination of operations selected from vehicle scheduling, goods picking, packaging, loading, dispatching, checking on delivery, and shelving.

5. A digital transport method using a digital transport system, the digital transport method applied to a warehouse environment having a plurality of storage areas, each storage area providing goods storage for a plurality of goods senders and recipients; the digital transport method comprising:
a connection step: connecting a warehouse management system of each of the senders and each of the recipients through an application interface:
a transport setting step: each sender and recipient setting a transport request of goods as a direct transport on the warehouse management system;
a task determining step: the application interface receiving a request task from the warehouse management system of the sender, the application interface determining if the transport request corresponding to the request task is the direct transport; when the application interface determines that the transport request corresponding to the request task is the direct transport, the application interface generates a simplified signal, wherein the request task comprises a task information and one corresponding recipient;
a simplified reporting step: the application interface sending the task information of the request task and an integrated report command to the warehouse management system of the recipient, the warehouse management system of the recipient automatically completing a goods transport report of the request task in the warehouse management system according to the integrated report command.

6. The digital transport method of claim 5, wherein when the request task is a purchase request, the recipient is allowed to establish a purchase order from an enterprise resource planning system; the enterprise resource planning system sends the purchase order to an enterprise resource planning system of the sender; the enterprise resource planning system of the sender establishes an outbound order based on the purchase order, and the sender transmits the outbound order to the warehouse management system of the sender.

7. The digital transport method of claim 6, wherein in the simplified reporting step, according to the simplified signal, the application interface determines if the warehouse management system of the recipient has set the transport request as the direct transport; when the application interface determines that the warehouse management system of the recipient has set the transport request as the direct transport, the application interface sends the task information of the request task and the integrated report command to the warehouse management system of the recipient.

8. The digital transport method of claim 7, wherein the integrated report command is used to conduct the goods transport report which includes two and/or a combination of operations selected from vehicle scheduling, goods picking, packaging, loading, dispatching, checking on delivery, and shelving.
